(19) United States
(12) Patent Application Publication
(10) Pub. No.: US 2010/0224218 A1
(43) Pub. Date: Sep. 9, 2010

(54) SYSTEM FOR OFFERING AND PROVIDING CLEANING APPARATUS TO CONSUMERS

(75) Inventor: KENNETH HOULBROOK, Stourton (GB)

Correspondence Address: MCKEE, VOORHEES & SEASE, P.L.C., 801 GRAND AVENUE, SUITE 3200, DES MOINES, IA, 50309-2721, US

(73) Assignee: CLANTEX LTD, Leeds (GB)

(21) Appl. No.: 12/717,462

(22) Filed: Mar. 4, 2010

(30) Foreign Application Priority Data
Mar. 5, 2009 (GB) 0903782.1

(51) Int. Cl. B08B 7/04

(52) U.S. Cl. 134/18; 134/56 R

(57) ABSTRACT

A system for providing cleaning apparatus, said system comprising providing a user accessible order unit via which options for the provision of the cleaning apparatus and/or cleaning product for use therewith are made available to a customer. The customer can select the cleaning apparatus option required and select a time and date and location at which said cleaning apparatus is required and the data for this is transmitted from the order unit to a remote processing hub. The cleaning apparatus which is required is identified and a delivery schedule established so as to allow the cleaning apparatus to be delivered at the selected date and time at the cleaning location.

### BACKGROUND OF THE INVENTION

The invention to which this application relates is a system and method which allows cleaning apparatus to be made available to consumers, for use, in a manner which is efficient, and allows the apparatus to be provided to the consumer as and when required, while, at the same time, ensuring that the apparatus owners and/or provider are able to track and organize usage of the same.

Conventionally, cleaning apparatus for use in a domestic or industrial premises is provided either in the accompaniment of at least one operator to use the apparatus to perform the cleaning operation at the premises, or, alternatively, is collected from a concession stand at a retail premises or shop and then transported to the cleaning location for use by the customer. The type of apparatus in question is typically that which is too expensive to be bought outright by customers and is therefore rented for use at time intervals and/or after an event which creates a need for the apparatus. In practice it is found that when an order is made via the concession stand, the customer pays the organization or owner of the premises in which the concession stand is located and the provider of the apparatus and/or cleaning product then has to wait to receive the payment from the said organization or premises owner thereafter, and typically after the apparatus and product has been used. This is an unwieldy procedure and can create a cash flow problem for the apparatus and/or product provider.

It is found in practice that when the apparatus is provided along with an operator, it is inefficient in as much that it can be difficult to secure a date and time at which the availability of the customer and operator coincide in order to allow the clean to be performed. The provision of the apparatus with the operator can also mean that the cleaning operation is relatively expensive to the customer such that no cleaning operation is performed at all. Furthermore, with regard to the system of providing the apparatus in which the apparatus is provided for collection by the customer, then often the customer may not be able to transport the cleaning apparatus to the location in their vehicle and/or the apparatus may not be available for collection at the desired time by the customer. It is therefore believed that the potential market for providing cleaning apparatus is not currently being met due to the difficulties indicated above.

The aim of the present invention is therefore to provide a method and system which allows cleaning apparatus to be provided to customers in an efficient manner thereby allowing the cleaning operation to be performed and the potential market demand to be fully exploited.

### BRIEF SUMMARY OF THE INVENTION

In a first aspect of the invention, there is provided a system for providing cleaning apparatus, said system comprising providing a user accessible order unit via which options for the provision of the cleaning apparatus are made available to a customer, the customer selecting the cleaning apparatus option required and selecting a time and date and location at which said cleaning apparatus is required and wherein data is transmitted from said order unit to a remote processing hub and, on receipt of that data, the cleaning apparatus which is required is identified and a delivery schedule established so as to allow the cleaning apparatus to be delivered at the selected date and time to the cleaning location.

A specific embodiment of the invention as now described with reference to the accompanying drawings wherein;

### BRIEF DESCRIPTION OF THE DRAWINGS

FIG. 1 illustrates a system in accordance with one embodiment of the invention in a schematic manner; and

FIG. 2 illustrates a flow chart of the method in accordance with one embodiment of the invention.

### DETAILED DESCRIPTION OF THE PREFERRED EMBODIMENTS

Typically the order unit includes a display screen and/or a customer interface for the unit. The unit typically also includes a means to allow the customer to make a payment.

Typically the customer can also select chemical cleaning products to be used in conjunction with the apparatus via the unit.

In one embodiment the order unit includes a communication means such as a phone, but more typically the unit is provided with an internet or other data connection means. The provision of the phone allows the customer to speak directly with the apparatus/product provider to allow ordering and/or discussion relating to the apparatus and or products to be used therein.

In one embodiment the order unit carries advertising to allow the customer to be able to identify the means by which the apparatus and cleaning products may be ordered at some later time.

Typically, the system includes a means whereby the user can select a date and time at which the apparatus will be available to be returned and a schedule is generated to allow said apparatus to be collected from the cleaning location.

In one embodiment, the apparatus is delivered for use by the customer to perform the cleaning operation.

In an alternative embodiment, the apparatus is delivered and used by a designated operator of the company, typically the person who has delivered the cleaning apparatus.

In one embodiment, the order unit is provided in a form for location at a retail premises or public space such as, for example, a supermarket. The order unit operation is remotely controlled by the provider of the cleaning apparatus and is provided with a communication link between the order unit and the hub operated by the provider of the cleaning apparatus.

Preferably the order unit includes at least one means by which the customer may make a payment for part or all of the costs of the provision of the apparatus and/or cleaning products. Typically this payment is made directly to the apparatus and/or product provider rather than to the third party organization which owns the premises in which the order unit is located. Typically the apparatus/product provider will make a separate payment to the third party organization for hire or lease of the space occupied by the order unit.

The invention as herein described therefore allows the cleaning apparatus provider to have a presence at locations where potential user's of the apparatus will already be visiting such as, for example supermarkets, railway stations, airports or the like and, importantly, allows the provider to have a presence at these locations without the need to also have cleaning apparatus kept at that location for collection or staff members employed to be present to process the orders. This therefore means that the cleaning apparatus is not provided at locations where the same may simply be held in storage for a significant period of time and, furthermore, it means that the operation explanation of operation and/or management of the cleaning apparatus is not required to be performed by unskilled and/or uninterested employees of a different organization i.e. of the retail premises. It also means that the amount of administration is greatly reduced as, in effect, the customer fills out the details themselves and this is passed directly either verbally or electronically to the apparatus/product provider.

Furthermore, the provision of the cleaning apparatus can be achieved without the need to provide an operator to operate the cleaning apparatus and therefore the possible date and times of delivery and use of the cleaning apparatus, are significantly increased as there is no need to take into account operator availability.

In a further aspect of the invention there is provided a method for providing cleaning apparatus for use at a customer location, said method comprising receiving at a processing hub, data from a remote order unit, wherein said data represents a customer order input via the order unit, identifying the cleaning apparatus and/or chemical cleaning products required, generating a delivery schedule to match the request of the customer, delivering the cleaning apparatus to the location of use and then collecting apparatus at a designated time thereafter from the said location.

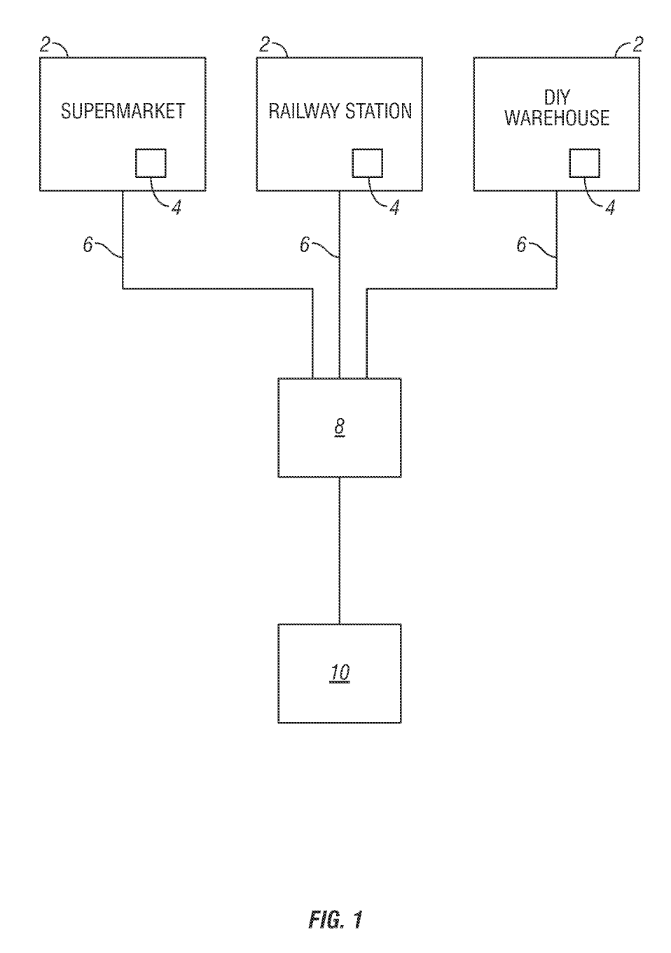

Referring firstly to FIG. 1, there is illustrated a series of retail or public premises 2 which, in this embodiment, comprise a supermarket, railway station and a DIY warehouse. At each of these locations, there is provided an order unit 4 in accordance with the invention. The order unit comprises a display screen which, typically, will be a touch screen and control means which form a customer interface for operation of the order unit. Each order unit 4 is provided with a communication link 6 to a central data processing hub 8 which is operated by the provider of the order unit 4. The hub 8 can also be provided with a phone connection as an alternative means of ordering and/or internet access. The hub 8 is provided to receive data from each of the order units 4, process the same and then generate a delivery schedule for delivery of cleaning apparatus to a cleaning location 10 at which the cleaning apparatus is to be used, either by the customer, or by an operator employed by the owner or provider of the cleaning apparatus.

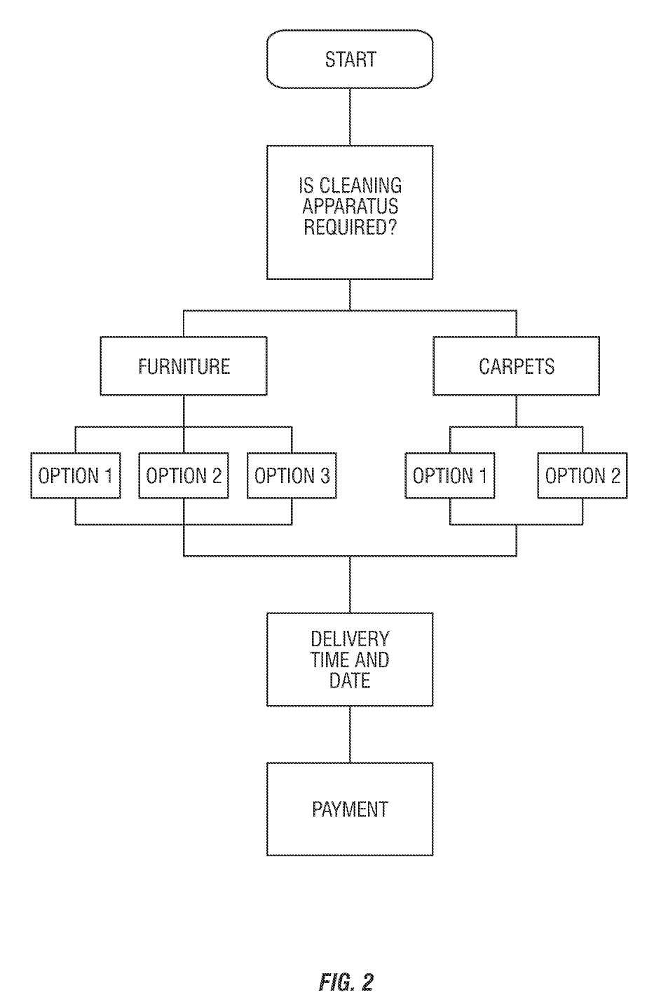

Turning now to FIG. 2, the operation of the method in accordance with one embodiment of the invention is now described. To commence use of the system, the potential customer interacts with an order unit 4 at one of the locations 2. By pressing start or otherwise commencing operation of the order unit 4 the user will be requested to confirm whether it is cleaning apparatus and/or chemical cleaning product that they wish to hire. If the answer is yes to the apparatus then they will be questioned as to the type of apparatus required in relation to whether the apparatus is for furniture or rugs and carpets. Depending on the answer given by the customer interacting with the order unit 4 then a range of options is presented to the customer via the display screen, with each option representing a particular cleaning package which can be chosen by the customer to suit their specific needs. Typically, in each of the group of options, the customer will be able to choose whether they wish to use the cleaning apparatus themselves or whether they wish the same to be used by an employee of the apparatus provider. In addition, the customer is then able to select a delivery time and date for the apparatus and, once selected, make payment via the order unit 4.

Preferably the user is also required to pay a deposit or pay the full amount due via the order unit hence ensuring that the apparatus provider receives payment in advance of supplying the apparatus and any cleaning product. This is an important feature as it allows the customer to pay the apparatus/product owner or provider directly rather than the conventional method whereby the customer typically pays the third party who stocks the equipment for hire. This therefore avoids conventional significant delay in the payment reaching the apparatus provider.

At this point, the customer interaction with the unit is finished and they do not have to collect any apparatus at that location. The data generated as a result of this interaction is processed by the data processing hub 8 and entered into a delivery schedule such that the cleaning apparatus and/or operator is available to be delivered at the cleaning location identified by the customer at the required date and time.

Thereafter, the customer simply has to be available at the required time and date to take delivery of the apparatus and, if required, use the same and to then also be available at a preselected date and time for the apparatus to be collected and returned to the apparatus provider or owner.

What is claimed is:

1. A system for providing cleaning apparatus, said system comprising providing a user accessible order unit via which options for the provision of the cleaning apparatus are made available to a customer, the customer selecting the cleaning apparatus option required and selecting a time and date and location at which said cleaning apparatus is required and wherein data is transmitted from said order unit to a remote processing hub and, on receipt of that data, the cleaning apparatus which is required is identified and a delivery schedule established so as to allow the cleaning apparatus to be delivered at the selected date and time to the cleaning location.

2. A system according to claim 1 wherein the order unit includes a display screen and/or a customer interface for the unit.

3. A system according to claim 1 wherein the order unit includes a means to allow the customer to make a payment.

4. A system according to claim 1 wherein the order unit provides the customer with the opportunity to select chemical cleaning products to be used in conjunction with the apparatus.

5. A system according to claim 1 wherein the order unit includes communication means in the form of any or any combination of a phone, internet, and/or other data connection means to allow the customer order and/or discuss issues relating to, the apparatus and or products to be used therein.

6. A system according to claim 1 wherein the order unit carries advertising to allow the customer to be able to identify the means by which the apparatus and cleaning products may be ordered at some later time.

7. A system according to claim 1 wherein the system includes a means whereby the user can select a date and time at which the apparatus will be available to be returned and a schedule is generated to allow said apparatus to be collected from the cleaning location.

8. A system according to claim 1 wherein the apparatus is delivered for use by the customer to perform the cleaning operation.

9. A system according to claim 1 wherein the apparatus is delivered and used by a designated operator.

10. A system according to claim 1 wherein the order unit is provided for location at a retail premises or public space

11. A system according to claim 1 wherein the unit operation is remotely controlled by the provider of the cleaning apparatus and is provided with a communication link between the unit and processing hub operated by the provider of the cleaning apparatus.

12. A method for providing cleaning apparatus for use at a customer location, said method comprising receiving at a processing hub, data from a remote order unit, wherein said data represents a customer order input via the unit, identifying the cleaning apparatus and/or chemical cleaning products required, generating a delivery schedule to match the request of the customer, delivering the cleaning apparatus to the location of use and then collecting apparatus at a designated time thereafter from the said location.
